(19) United States
(12) Patent Application Publication
(10) Pub. No.: US 2015/0355574 A1
(43) Pub. Date: Dec. 10, 2015

(54) IMAGE FORMING APPARATUS

(71) Applicant: CANON KABUSHIKI KAISHA, Tokyo (JP)

(72) Inventor: Katsuya Nose, Kashiwa-shi (JP)

(21) Appl. No.: 14/727,917

(22) Filed: Jun. 2, 2015

(30) Foreign Application Priority Data
Jun. 9, 2014 (JP) 2014-118352

(51) Int. Cl. G03G 15/08

(52) U.S. Cl. CPC G03G 15/0848; G03G 15/556

(57) ABSTRACT

An image forming apparatus performs a scattered toner ejection control mode in which toner is discharged from a developer bearing member to a region on an image bearing member corresponding to an interval between a preceding recording material and a subsequent recording material while applying only a DC voltage to a developer bearing member based on toner consumption information and a degraded toner ejection control mode in which toner is discharged from the developer bearing member to a region on the image bearing member corresponding to an interval between a preceding recording material and a subsequent recording material while applying at least an AC voltage to the developer bearing member based on toner consumption information, the controller changing a performing ratio of the scattered toner ejection control mode to the degraded toner ejection control mode depending on the temperature sensed by a temperature sensing portion.

### BACKGROUND OF THE INVENTION

1. Field of the Invention

The present invention relates to an image forming apparatus such as an electrophotographic copying machine or a laser beam printer including a developing device that develops an electrostatic latent image formed on an image bearing member to a toner image.

2. Description of the Related Art

In a two-component development type developing device, a magnetic brush development method using a developing sleeve which is a developer carrying member is generally used. This development method is used in a lot of products such as a black-and-white digital copying machine or a full color copying machine required for high image quality.

In order to efficiently develop an electrostatic latent image on a photosensitive drum, a two-component developer includes powder of a magnetic material, for example, a magnetic carrier of ferrite, and a toner in which a pigment is dispersed in a resin. The two-component developer is agitated and mixed and the toner is made to hold electric charge by frictional charging using mutual friction.

In a state in which the two-component developer is carried by the developing sleeve, the two-component developer on the developing sleeve is transported from a developer container to a developing area facing the photosensitive drum. By an action of a magnetic field in the developing area, the developer is napped to construct a magnetic brush. The magnetic brush is brought into frictional contact with the surface of the photosensitive drum. Accordingly, the electrostatic latent image formed on the photosensitive drum is developed with the developer.

In an image forming apparatus using the developing device, there is a problem with apparatus contamination due to scattered toner. That is, a developer flies apart in the developing area between the photosensitive drum and the developing sleeve. At this time, the toner floats in air to serve as scattered toner. Here, the scattered toner leaks to the outside of the developing device from a vertical gap between the developing device and the photosensitive drum.

An LED, an optical system, a transfer unit, a conveyance path, and the like are often arranged in the upper and lower parts of the developing device. Accordingly, problems such as operation failure or degradation of various members and toner contamination of an output image occur.

In the related art, as a technique of preventing toner scattering on the downstream side of a rotation direction of the developing sleeve, a technique of applying a scattered toner prevention bias is known (U.S. Patent Application Publication No. 2010/247164 A1). In this technique, a scattering-prevention electrode is disposed to prevent toner from being scattered from the inside of the developing container. The scattering-prevention electrode may be disposed at a position on the upper side of the developing sleeve in the vertical direction and on the downstream side in the rotation direction of the developing sleeve from a straight line passing through two points, that is, the rotation center point o of the developing sleeve and a vertex.

Japanese Patent Laid-Open No. 2000-112237 proposes a technique of providing a scattered toner collection roller as a technique of preventing toner from being scattered from the lower part of a developing device. In the technique described in Japanese Patent Laid-Open No. 2000-112237, the collection roller is disposed close to the downstream side of the rotation direction of the developing sleeve from a position at which a photosensitive member comes into contact with a developing sleeve.

A bias voltage is applied to the collection roller and rotates in the opposite direction of the developing sleeve. The toner scattered from the developing area is deposited or adsorbed on the collection roller located below. The toner deposited on the collection roller is transported with the rotational drive of the collection roller, is scraped off with a scraper, and is collected in a developing container. Accordingly, the toner scattered from the developing sleeve is prevented from leaking to the outside of the developing container.

However, in a developing device including a scattering-prevention bias electrode as described in U.S. Patent Application Publication No. 2010/247164 A1, an electrode used to apply a scattering-prevention bias needs to be disposed in a developing container. A high-voltage substrate (or a high-voltage rectifier base) used to apply the scattering-prevention bias is provided. In the technique described in Japanese Patent Laid-Open No. 2000-112237, the correction roller needs to be provided. In this way, when a particular unit for preventing toner from being scattered is disposed in a developing device, a space is occupied and a cost increases. Accordingly, there is a problem with an increase in cost and an increase in size of a developing device.

### SUMMARY OF THE INVENTION

It is desirable to provide an image forming apparatus which can prevent toner from being scattered with an inexpensive configuration.

According to a representative configuration of the invention, there is provided an image forming apparatus comprising:

an image bearing member;

a developer containing portion that contains a developer including toner;

a developer bearing member that bears the developer in the developer containing portion and that supplies the developer to an electrostatic latent image formed on the image bearing member;

a toner replenishment portion that replenishes the developer containing portion with toner;

a power supply portion that applies an AC voltage or a voltage in which a DC voltage and an AC voltage are superimposed to the developer bearing member at least during image formation;

an information obtaining portion which obtains information concerning toner consumption amount;

a temperature sensing portion that senses a temperature in the image forming apparatus; and

a controller which can perform a scattered toner ejection control mode in which toner is discharged from the developer bearing member to a region on the image bearing member corresponding to an interval between a preceding recording material and a subsequent recording material while applying only a DC voltage to the developer bearing member based on the information obtained by the information obtaining portion during an image forming period in which an image is successively formed on recording materials and a degraded toner ejection control mode in which toner is discharged from the developer bearing member to a region on the image bearing member corresponding to an interval between a preceding recording material and a subsequent recording material while applying at least an AC voltage to the developer bearing member based on the information obtained by the information obtaining portion during an image forming period in which an image is successively formed on recording materials, the controller changing a performing ratio of the scattered toner ejection control mode to the degraded toner ejection control mode depending on the temperature sensed by the temperature sensing portion.

Further features of the present invention will become apparent from the following description of exemplary embodiments with reference to the attached drawings.

### BRIEF DESCRIPTION OF THE DRAWINGS

FIG. 1 is a diagram schematically illustrating an image forming apparatus.

FIG. 2 is a diagram schematically illustrating a configuration around a photosensitive drum of the image forming apparatus.

FIG. 3 is a block diagram illustrating a system configuration of an image processing unit.

FIG. 4 is a cross-sectional view schematically illustrating a developing device.

FIG. 5 is a longitudinal-sectional view schematically illustrating the developing device.

FIG. 6 is a control block diagram of a temperature sensor.

FIG. 7 is a table illustrating dependency of toner scattering on a printing rate.

FIG. 8 is a graph illustrating a particle diameter distribution of scattered toner at a printing rate of 1% and 5%.

FIG. 9 is a table illustrating a toner scattered threshold video count according to a first embodiment.

FIG. 10 is a flowchart illustrating a control flow up to scattered toner ejection control according to the first embodiment.

FIG. 11 is a flowchart illustrating a control flow of the scattered toner ejection control according to the first embodiment.

FIG. 12 is a diagram illustrating a particle diameter distribution of toner which is ejected in the scattered toner ejection control according to the first embodiment.

FIG. 13 is a table illustrating the scattered toner ejection control according to the first embodiment.

FIG. 14 is a control block diagram illustrating a scattered toner ejection operation according to the first embodiment.

FIG. 15 is a flowchart illustrating a flow of toner ejection control according to a second embodiment.

FIG. 16 is a table illustrating a toner degradation threshold of each color according to the second embodiment.

FIG. 17 is a table illustrating a threshold of temperature dependency of scattered toner due to toner aggregates of each color according to the first embodiment.

FIG. 18 is a graph illustrating a temperature rise of a developer when images are continuously formed according to the second embodiment.

FIG. 19 is a control block diagram illustrating a toner ejection operation according to the second embodiment.

### DESCRIPTION OF THE EMBODIMENTS

### First Embodiment

An image forming apparatus according to a first embodiment will be described below in detail. The entire summary of the image forming apparatus will be first described and then a scattered toner ejection control mode as a feature thereof will be described.

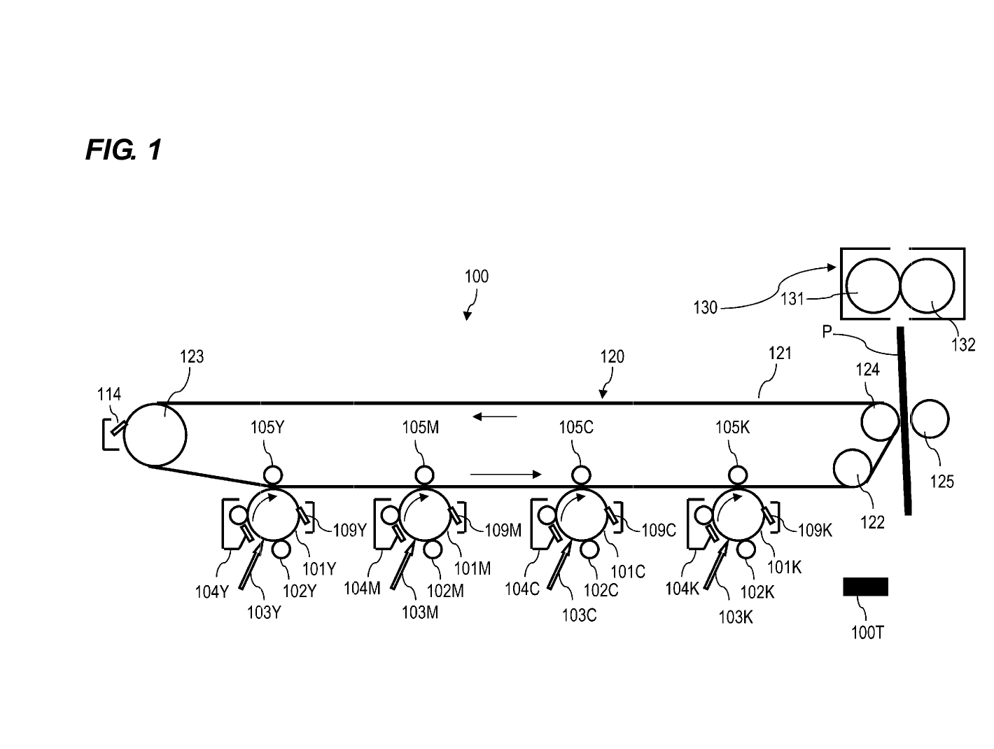

(Summary of Image Forming Apparatus to which the Invention can be Applied) FIG. 1 is a diagram schematically illustrating an image forming apparatus. In the following description, image forming stations form toner images of yellow Y, magenta M, cyan C, and black K colors, respectively. Since the image forming stations and the peripheral units thereof are the same, subscripts Y, M, C, and K will be appropriately omitted in the following description.

As illustrated in FIG. 1, an image forming portion of the image forming apparatus 100 to which the invention can be applied includes four image forming stations. Each image forming station includes a photosensitive drum 101 (101Y, 101M, 101C, and 101K) as an image bearing member.

An intermediate transfer device 120 is disposed above the image forming stations. In the intermediate transfer device 120, an intermediate transfer belt 121 (intermediate transfer member) is suspended on a roller 122, a roller 123, and a roller 124 and is configured to run in the arrow direction.

In formation of an image, first, the surface of the photosensitive drum 101 is charged with a primary charging device 102 (102Y, 102M, 102C, and 102K) of a contact-charging type charging roller system. Then, the surface of the photosensitive drum 101 is exposed with a laser beam 103 (103Y, 103M, 103C, and 103K) applied from an exposure device by a laser driver (not illustrated). Accordingly, an electrostatic latent image is formed on the photosensitive drum 101.

The electrostatic latent image is developed by a developing device 104 (104Y, 104M, 104C, and 104K). Accordingly, toner images of yellow, magenta, cyan, and black are formed.

The toner images formed on the image forming stations are transferred onto the intermediate transfer belt 121 formed of a polyimide-based resin by a transfer bias from primary transfer rollers 105 (105Y, 105M, 105C, and 105K: primary transfer members) and are superimposed thereon.

Four color toner images formed on the intermediate transfer belt 121 are transferred onto a recording material P by a secondary transfer roller 125 (secondary transfer member) disposed to face the roller 124. Residual toner which is not transferred onto the recording material P but remains on the intermediate transfer belt 121 is removed by a belt cleaner 114.

The recording material P onto which the toner images are transferred is pressurized/heated by a fixing device 130 including a pressure roller 131 and a heating roller 132, whereby a permanent image is obtained. The primary transfer residual toner remaining on the photosensitive drum 101 after the primary transfer is removed by cleaning blade contact type drum cleaners 109 (109Y, 109M, 109C, and 109K) to prepare for next formation of an image.

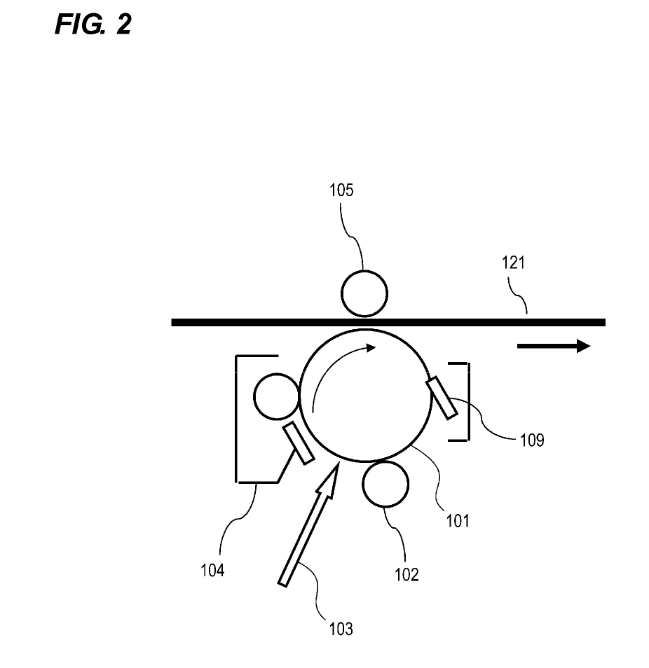

(Configuration around Photosensitive Drum of Image Forming Apparatus) FIG. 2 is a diagram schematically illustrating the configuration around the photosensitive drum of the image forming apparatus. The configuration around the photosensitive drum 101 will be described below in detail with reference to FIG. 2.

As illustrated in FIG. 2, each image forming station includes a primary charging device 102, a space which is irradiated with a laser beam 103, a developing device 104, and a drum cleaner 109 around the photosensitive drum 101. The image forming station further includes a primary transfer roller 105 with the intermediate transfer belt 121 interposed therebetween.

In an image forming operation, first, the photosensitive drum 101 which is disposed to freely rotate is uniformly charged with the primary charging device 102 of a contact-charging type charging roller system. Then, the surface of the photosensitive drum 101 is exposed with the laser beam 103. Accordingly, an electrostatic latent image is formed on the photosensitive drum 101. The electrostatic latent image is visualized by the developing device 104. The visible image is primarily transferred onto the intermediate transfer belt 121 by the primary transfer roller 105.

The transfer residual toner on the photosensitive drum 101 after the primary transfer is removed by the cleaning blade contact type drum cleaner 109. The potential on the photosensitive drum 101 is erased by an exposure lamp 110 and the photosensitive drum 101 is provided for formation of an image again.

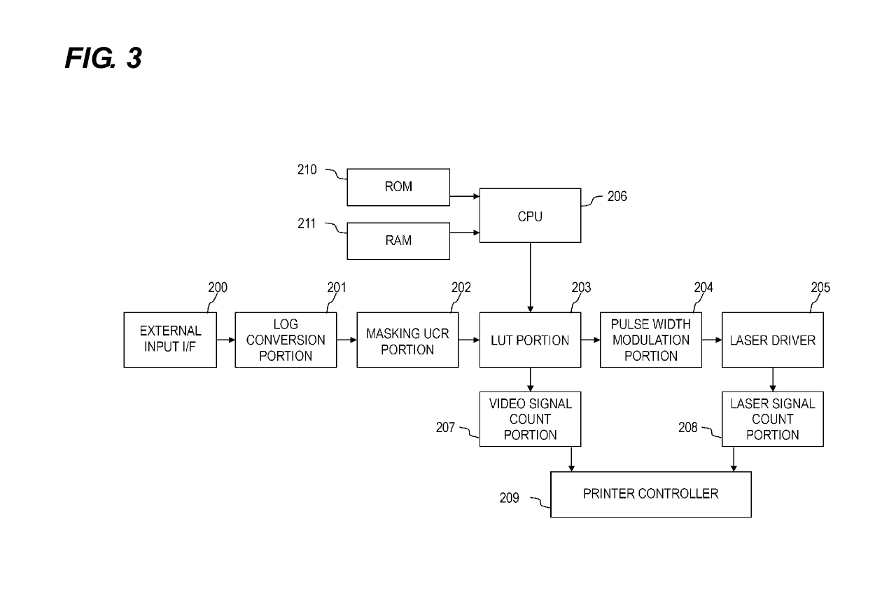

(Summary of Image Processing) A system configuration of the image processing unit in the image forming apparatus 100 according to this embodiment will be described below. FIG. 3 is a block diagram illustrating the system configuration of the image processing unit.

As illustrated in FIG. 3, color image data is input from an external input interface 200 (external input I/F). The color image data is input as RGB image data from an external device (not illustrated) such as an original scanner or a computer (information processing apparatus) if necessary.

An LOG conversion portion 201 converts brightness data of the input RGB image data to CMY density data (CMY image data) based on a lookup table (LUT) including data stored in ROM 210 or the like.

A masking UCR portion 202 extracts black (K) component data from the CMY image data and performs a matrix calculation on the CMKY data so as to correct color turbidness of a recording color material.

A LUT portion 203 (lookup table portion) performs density correction for each color of the input CMYK image data using a gamma lookup table (γ lookup table) so as to correspond image data to an ideal gradation characteristic of a printer portion. The γ lookup table is prepared based on data loaded onto RAM 211 and details of the table are set by a CPU 206.

A pulse width modulation portion 204 outputs a pulse signal of a pulse width corresponding to a level of the image data (image signal) input from the LUT portion 203. The laser driver 205 forms an electrostatic latent image by driving a light-emitting element of the laser beam 103 and irradiating the photosensitive drum 101 with the laser beam based on the pulse signal.

A video signal count portion 207 (count portion) integrates a level (level of 0 to 255) for each pixel at 600 dpi of the image data input to the LUT portion 203 by a sheet of image. The integrated value of the image data is referred to as a video count value. The video count value has a maximum value 1023 when the entire output image is at a level of 255. When a circuit configuration is limited, the image signal from the laser driver 205 is similarly calculated using a laser signal count portion 208 instead of the video signal count portion 207. Accordingly, the video count value can be calculated.

A printer controller 209 (controller) controls the portions of the image forming apparatus 100 based on information acquired from the video signal count portion 207 or the laser signal count portion 208.

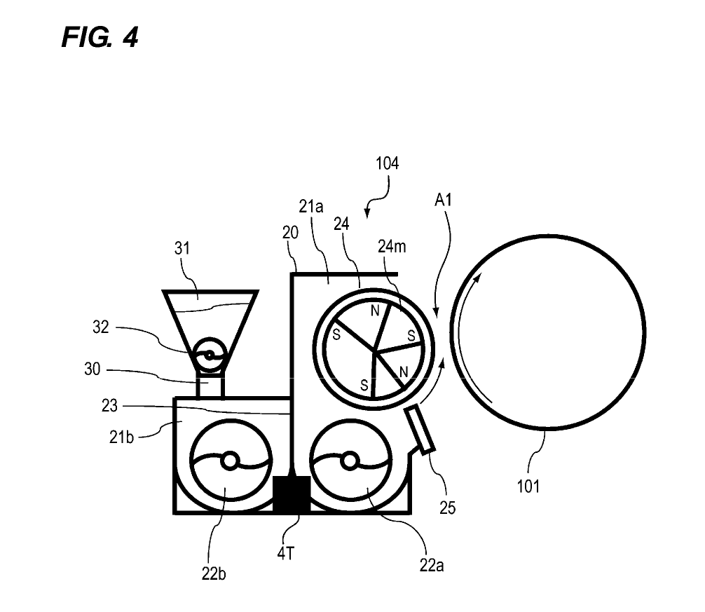

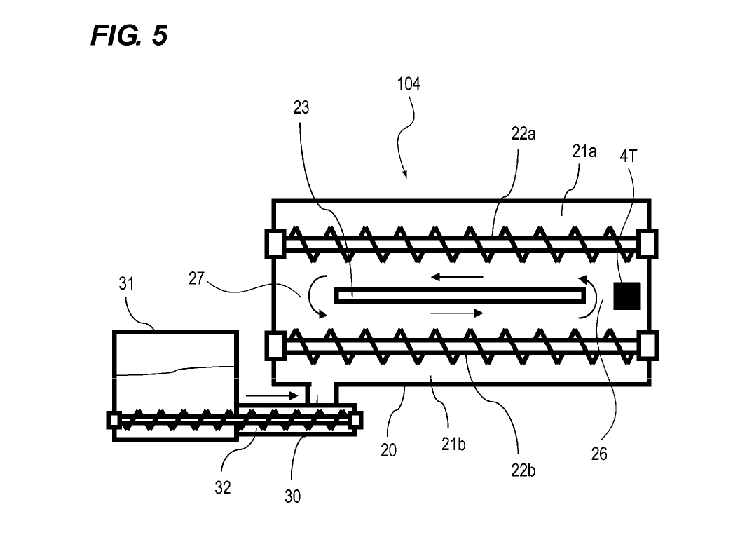

(Configuration of Developing Device) The developing device 104 will be described in detail. FIG. 4 is a cross-sectional view schematically illustrating the developing device. FIG. 5 is a longitudinal sectional view schematically illustrating the developing device.

As illustrated in FIGS. 4 and 5, the developing device 104 includes a developing container 20 (developer containing portion) and a two-component developer including toner and carriers is contained as a developer in the developing container 20. A developing sleeve 24 (developer carrying member) and a regulation blade 25 (nap removing member) configured to regulate a nap of the developer carried on the developing sleeve 24 are disposed in the developing container 20.

In the developing container 20, the substantially central part thereof is partitioned in the horizontal direction into a developing chamber 21a and an agitation chamber 21b by a partition wall 23 extending in the vertical direction with respect to the drawing surface. The developer is contained in the developing chamber 21a and the agitation chamber 21b.

A first agitation screw 22a and a second agitation screw 22b which are transport members as a developer agitation and transport unit are disposed in the developing chamber 21a and the agitation chamber 21b, respectively.

The first agitation screw 22a is disposed on the bottom of the developing chamber 21a so as to be substantially parallel to the axial direction of the developing sleeve 24. With the rotation of the first agitation screw 22a, the developer in the developing chamber 21a is conveyed in one direction along the axial direction.

The second agitation screw 22b is disposed on the bottom of the agitation chamber 21b so as to be substantially parallel to the first agitation screw 22a and conveys the developer in the agitation chamber 21b in the opposite direction of the first agitation screw 22a.

In this way, by transportation using the rotation of the first agitation screw 22a and the second agitation screw 22b, the developer circulates between the developing chamber 21a and the agitation chamber 21b via a communication portion 26 and a communication portion 27 (see FIG. 5) formed at both ends of the partition wall 23. A temperature sensor 4T (temperature sensing portion) is disposed in the communication portion 26. Details of the temperature sensor 4T will be described later.

The developing chamber 21a and the agitation chamber 21b are disposed in parallel in the horizontal direction, but the invention can be applied to a developing device in which the developing chamber 21a and the agitation chamber 21b are disposed in the vertical direction or other developing devices.

An opening is formed at a position corresponding to a developing area A1 (see FIG. 4) of the developing container 20 facing the photosensitive drum 101, and the developing sleeve 24 is rotationally disposed in the opening so as to expose a part thereof to the photosensitive drum.

In this embodiment, the diameter of the developing sleeve 24 is 20 mm, the diameter of the photosensitive drum 101 is 30 mm, and the shortest distance between the developing sleeve 24 and the photosensitive drum 101 is about 300 μm. In this configuration, development is performed in a state in which the developer transported to the developing area A1 comes into contact with the photosensitive drum 101. The developing sleeve 24 is formed of a nonmagnetic material such as aluminum or stainless steel and a magnet roller 24m as a magnetization unit is disposed in a non-rotatable state therein.

(Operation of Developing Device) In the configuration, the developing sleeve 24 rotates in the arrow direction illustrated in FIG. 4 at the time of development, and carries two-component developer with a thickness regulated with the nap removal by the magnetic brush of the regulation blade 25. The developing sleeve 24 transports the developer with a thickness regulated to the developing area A1 facing the photosensitive drum 101 and supplies the developer to the electrostatic latent image formed on the imaged part of the photosensitive drum 101 to develop the electrostatic latent image.

At this time, in order to improve development efficiency (rate of supplying the toner to the electrostatic latent image), a development bias voltage having a DC voltage and an AC voltage superimposed is applied to the developing sleeve 24 during formation of an image from a power supply. In this embodiment, a DC voltage of −500 V and an AC voltage with a peak-to-peak voltage Vpp of 1800 V and a frequency f of 12 kHz are used. However, the DC voltage value and the AC voltage waveform are not limited to this example.

In general, in a two-component magnetic brush developing method, when an AC voltage is applied, development efficiency increases and image quality increases, but fogging is likely to occur. Accordingly, a potential difference is provided between the DC voltage applied to the developing sleeve 24 and the charging potential of the photosensitive drum 101 (that is, white background potential). Accordingly, the fogging is prevented.

The regulation blade 25 is formed of a nonmagnetic member such as an aluminum plate extending along the axial direction of the developing sleeve 24. The regulation blade 25 is disposed on the upstream side in the developing sleeve rotation direction from the photosensitive drum 101. Both the toner and the carriers of the developer pass through the tip of the regulation blade 25 and the developing sleeve 24 and are sent to the developing area A1.

By adjusting the gap between the regulation blade 25 and the developing sleeve 24, the amount of nap removed by a developer magnetic brush carried on the developing sleeve 24 is regulated and the amount of developer transported to the developing area is adjusted. In this embodiment, the amount of developer coating per unit area on the developing sleeve 24 is limited to 30 mg/cm² by the regulation blade 25.

The gap between the regulation blade 25 and the developing sleeve 24 is set to range from 200 μm to 1000 μm and preferably from 300 μm to 700 μm. In this embodiment, the gap is set to 500 μm.

In the developing area A1, the developing sleeve 24 moves in the forward direction of the moving direction of the photosensitive drum 101 at a circumferential speed ratio of 1.80 times that of the photosensitive drum. The circumferential speed ratio is set between 0 to 3.0 times and preferably between 0.5 times to 2.0 times. As the moving velocity ratio becomes higher, the development efficiency becomes greater. However, when the moving speed ratio is excessively high, problems with scattered toner, developer degradation or the like occur and thus the above-mentioned range can be preferably set.

(Temperature Sensor) The temperature sensor 4T will be described in detail. As illustrated in FIGS. 4 and 5, the temperature sensor 4T is disposed in the communication portion 26 in the developing container 20. The position of the temperature sensor 4T in the developing container 20 is not particularly limited, but can be preferably set to a position at which a sensor surface is buried with the developer for the purpose of improvement in sensing accuracy.

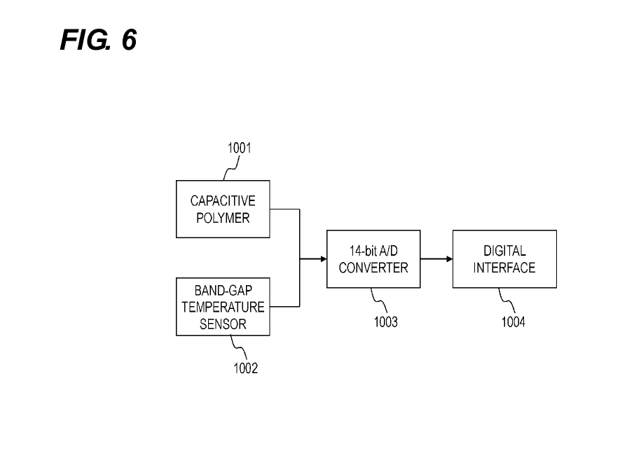

FIG. 6 is a control block diagram illustrating the temperature sensor. As illustrated in FIG. 6, the temperature sensor 4T has a capacitive polymer 1001 (humidity sensing device) as a sensing element and a band-gap temperature sensor 1002 mounted thereon. Both are CMOS devices coupled to an A/D converter 1003 of 14 bits and having specifications of performing serial output via a digital interface 1004.

The band-gap temperature sensor 1002 calculates a temperature from a resistance value of a thermistor using the thermistor in which the resistance value linearly varies with respect to the temperature.

The capacitive polymer 1001 is a capacitor having a polymer as a dielectric inserted. Since an amount of moisture adsorbed on the polymer varies depending on humidity, the capacitance of the capacitor linearly varies depending on the humidity. The capacitive polymer 1001 calculates humidity by converting the capacitance into humidity using these characteristics.

As described above, the temperature sensor 4T used in this embodiment can detect both the temperature and the humidity. However, the temperature sensor is not limited to this example, but may be a sensor that can sense only the temperature if necessary.

(Developer Replenishment Method of Developing Device) A developer replenishment method in this embodiment will be described below with reference to FIGS. 3 and 4. A hopper 31 (toner replenishment portion) that contains two-component developer for replenishment in which toner and carriers are mixed is disposed above the developing device 104. The toner and the replenishment developer are contained total 100% to 80% in the two-component developer for replenishment.

The hopper 31 includes a screw-like replenishment member, that is, a replenishment screw 32, in the lower part thereof. An end of the replenishment screw 32 extends to the position of a developer replenishment port 30 installed at the rear end of the developing device 104.

Toner consumed through formation of an image is supplied to the developing container 20 through the developer replenishment port 30 from the hopper 31 by the rotational force of the replenishment screw 32 and the gravitational force of the developer. The amount of replenishment developer supplied from the hopper 31 to the developing device 104 is substantially determined depending on a rotation speed of the replenishment screw 32. The rotation speed is determined by a toner replenishment controller (not illustrated) based on the video count value of image data, the sensing result of a toner density detecting portion (not illustrated) installed in the developing container 20.

(Summary of Developer of Developing Device) The two-component developer including toner and carriers which is contained in the developing container 20 of the developing device 104 according to this embodiment will be described below in detail. The developer of this embodiment is pulverized toner including wax.

The toner includes colored resin particles including a binder resin, a coloring agent, and other additives if necessary and colored particles including external additives such as colloidal silica fine powder. The toner is a polyester-based resin having minus chargeability and preferably has a volume-average particle diameter of 4 μm to 10 μm. More preferably, the volume-average particle diameter is equal to or less than 8 μm. In recent years, toner having a low melting point or toner in which the glass transition temperature Tg of the binder resin is low (for example, Tg is equal to or lower than 70° C.) is often used to improve fixability. Wax may be included in the toner to improve separability after fixation.

As the carriers, metal such as surface-oxidized or surface-unoxidized iron, nickel, cobalt, manganese, chromium, rare earth metal, alloys thereof, or oxide ferrite, or the like can be appropriately used and a method of manufacturing the magnetic particles is not particularly limited. The carriers have a weight-average particle diameter of 20 μm to 60 μm and preferably 30 μm to 50 μm and resistivity equal to or greater than 10⁷ Ωcm and preferably 10⁸ Ωcm. In this embodiment, the carriers having resistivity of 10⁸ Ωcm are used.

In the toner used in this embodiment, the volume-average particle diameter is measured using the following device and method. An electrical-resistance grain size distribution measuring device is used as the measuring device. The measuring method is as follows.

That is, 0.1 ml of a surfactant, preferably, alkyl benzene sulfonate, as a dispersing agent is added to 100 ml to 150 ml of an electrolyte aqueous solution of a 1% NaCl aqueous solution which is prepared using primary sodium chloride and 0.5 mg to 50 mg of a sample is added to the resultant. The electrolyte aqueous solution in which the sample is suspended is subjected to a dispersing process for about 1 to 3 minutes by an ultrasonic disperser. The grain size distribution of particles of 2 μm to 40 μm is measured using a 100 μm aperture as an aperture by the use of the SD-2000 sheath flow electrical-resistance grain size distribution measuring device and a volume-average distribution is calculated. The volume-average particle diameter is obtained from the calculated volume-average distribution.

The resistivity of the carriers used in this embodiment is measured using a sandwich type cell with a measuring electrode gap of 4 cm and an electrode gap of 0.4 cm. The resistivity is measured using a method of applying a voltage E (V/cm) across both electrodes in a state in which a pressure of 1 kilogram-weight is applied to one electrode and acquiring resistivity of carriers from a current flowing in a circuit.

(Control Method of Scattered Toner Ejection Control Mode) Hereinafter, an operation control method of a scattered toner ejection control mode which is a feature of this embodiment will be described in detail.

First, in the image forming apparatus 100 having the above-mentioned configuration, when formation of an image at a low printing rate is continuously performed, the ratio of toner moving from the developing container 20 to the photosensitive drum 101 decreases. Then, the toner in the developing container 20 is subjected to agitation by the first agitation screw 22a and the second agitation screw 22b for a long time. The toner is subjected to sliding friction for a long time when the toner passes through the regulation blade 25.

When the toner is subjected to the agitation or the sliding friction, the external additive of the toner is peeled off or the external additive is buried in the toner surface, whereby the external additive disappears from the toner surface. When the exposure of the resin surface as a partner becomes marked, the binding between the toner particles is strengthened. As a result, toner aggregates are generated. Particularly, in a pulverized toner system, the external additive is often added for the purpose of fluidity. Accordingly, when the external additive disappears, the fluidity of the toner degrades. Then, aggregates are likely to be generated.

When the temperature of the toner rises, the resin of the toner is softened and aggregation is more likely to occur. Accordingly, the temperature of the actual image forming apparatus 100 is preferably controlled using a wind force of a fan or the like so as not to be equal to or higher than a temperature of about 40° C. to 60° C.

When aggregates are generated in the developing container 20 as described above, the aggregates are flipped up by the first agitation screw 22a. Thereafter, the aggregates are carried by the developing sleeve 24 and reaches to the developing area A1. Then, the toner which flies with a higher probability in comparison with normal toner jumps out into the image forming apparatus 100.

The reason is as follows. That is, the aggregates have a greater volume than normal toner. The diameter of normal toner is about 6 μm, but the diameter of the aggregates is about 20 μm to 35 μm. Accordingly, since the mass of the aggregates increases, the aggregates are subjected to a centrifugal force due to the rotation of the developing sleeve 24 when the aggregates reach the developing area A1. Then, the aggregates are more likely to be scattered than the normal toner.

Therefore, in this embodiment, by causing the printer controller 209 to perform the following scattered toner ejection control, the toner aggregates are prevented from entering the apparatus. Specifically, when formation of images at a low printing rate is continuously performed, aggregates are formed, but the toner aggregates are selectively ejected to the photosensitive drum 101 before the aggregates are scattered. The aggregates ejected onto the photosensitive drum 101 are collected by the drum cleaner 109. The printer controller 209 can perform the scattered toner ejection control mode. In this embodiment, the control of selectively ejecting the toner aggregates onto the photosensitive drum 101 by applying a developing bias of a predetermined DC voltage to the developing sleeve 24 is performed.

Hereinafter, it will be described in this embodiment that a generation rate of toner aggregates varies depending on the printing rate of an image and a toner scattered level varies. Then, how to perform the scattered toner ejection control mode depending on the printing rate will be described.

(Relationship between Generation of Toner Aggregates and Amount of Scattered Toner Depending on Printing Rate of Image) As described above, when the ratio of the toner moving to the photosensitive drum 101 is low and the amount of toner supplied to the developing container 20 is small (the printing rate is low), the degradation of toner progresses and the toner aggregates are generated. Therefore, the inventors of the invention performed the following experiment. That is, the developing device 104 was placed under a predetermined environment (with a temperature of 23° C. and humidity of 50%), images were continuously formed on one sides of A4-size sheets while changing the printing rate (0% to 5%) of each color of YMCK. A variation in the amount of scattered toner was checked in the developing device 104 after the formation of images were continuously performed on 10000 sheets.

Here, the measurement on one side of sheets is performed as follows. That is, in the developing device 104, a measuring plain paper is wound to cover the developing area A1 and then the developing sleeve 24, the first agitation screw 22a, and the second agitation screw 22b idles for a predetermined time (one minute). An amount of scattered toner in the time and attached to the measuring plain paper is observed with an optical microscope and an image thereof is analyzed.

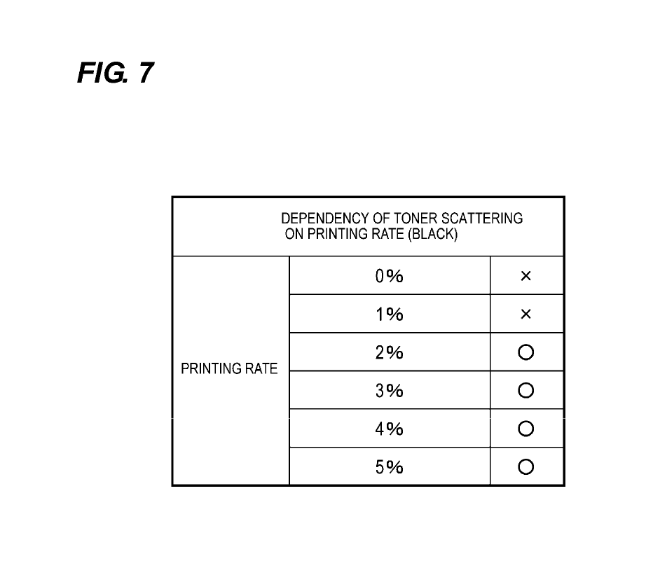

FIG. 7 is a table illustrating dependency of scattered toner on the printing rate. In FIG. 7, only the experiment result for black is illustrated. In FIG. 7, “◯” indicates that the amount of scattered toner is equal to or less than a predetermined target value. “x” indicates that the amount of scattered toner is greater than the predetermined target value. The predetermined target value in this embodiment is equal to or less than 3000 pieces/minute.

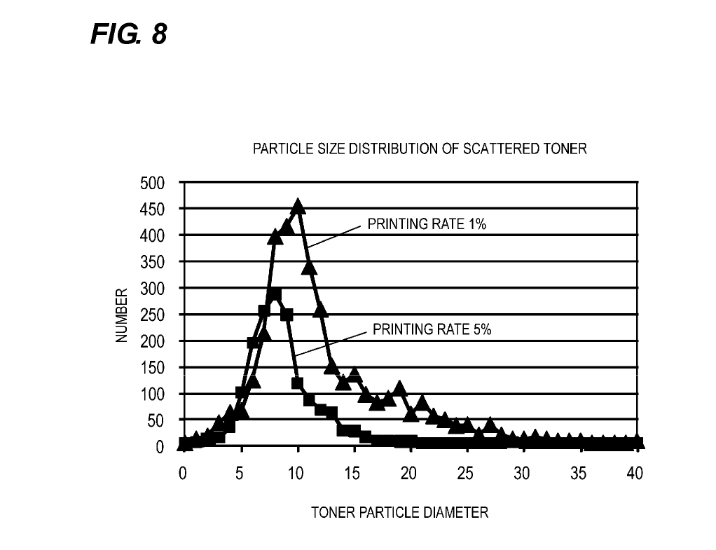

FIG. 8 is a graph illustrating a particle diameter distribution of scattered toner at a printing rate of 1% and 5%. In FIG. 8, the horizontal axis represents the toner particle diameter measured through the image analysis and the vertical axis represents the number of particles with the corresponding particle diameter. From the graph illustrated in FIG. 8, it can be seen that the amount of scattered toner in the developer standing at the printing rate of 1% is greater. The grain size distribution of the scattered toner at the printing rate of 1% is shifted closer to the large particle diameter than that at the printing rate of 5%. It can be seen that toner aggregates of about 20 μm to 35 μm are generated at the printing rate of 1%. When the toner attached to a plain paper for measuring an amount of scattered toner is actually observed with an optical microscope, the aggregated toner particles are observed.

From FIGS. 7 and 8 illustrating the experiment results, it can be seen that as the printing rate becomes lower, the toner aggregates are more likely to be generated and the toner aggregates are more likely to be scattered by the idling. In other words, in the image forming apparatus 100 according to this embodiment, when formation of an image at a predetermined printing rate or higher (that is, at a predetermined video count or higher) is not performed, the scattering due to the toner aggregates degrades.

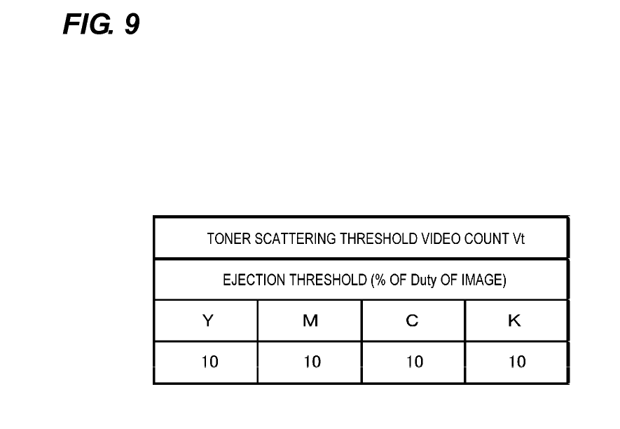

Therefore, in this embodiment, the video count corresponding to the amount of toner consumed which is necessary not to cause the degradation of scattering due to the toner aggregates is defined as a “toner scattering threshold video count Vt”. This is a value which can be calculated by the above-mentioned experiment or the like. Here, the toner scattering threshold video count Vt of each color in the image forming apparatus 100 according to this embodiment is illustrated in the table of FIG. 9.

FIG. 9 is a table illustrating the toner scattering threshold video count according to a first embodiment. Since the toner scattering threshold video count varies depending on colors or materials of the developer (toner and carriers), the configuration of the developing device, and the like, the toner scattering threshold video count can be appropriately calculated and set. The scattered toner ejection control is performed based on the values of the table of the toner scattering threshold video count Vt illustrated in FIG. 9.

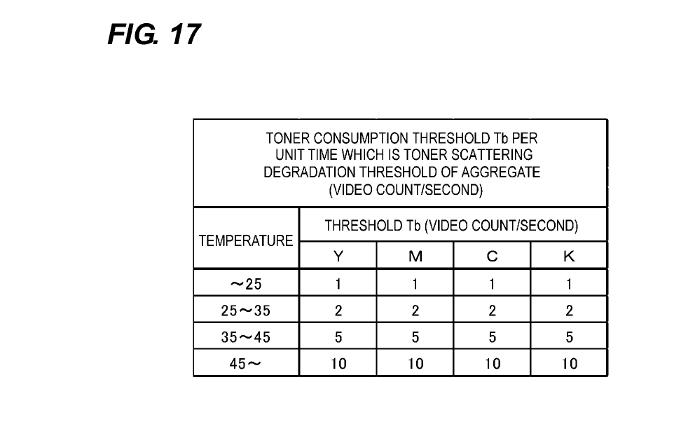

Here, the value of the toner scattering threshold video count Vt can be appropriately set depending on the sensed temperature of the apparatus. In this case, the temperature used as a basis for the printer controller 209 to perform the ejection control is based on the temperature information of the temperature sensor 4T illustrated in FIG. 4. However, the temperature is not limited to this example, but may be at least a temperature in the image forming apparatus 100 or may be based on a temperature sensor 100T installed in the image forming apparatus illustrated in FIG. 1. Regarding the value of the toner scattering threshold video count Vt in this embodiment, the value of the toner scattering threshold video count Vt is set such that the higher the temperature becomes, the higher the exposure frequency becomes as illustrated in FIG. 17 and described later.

(Control Method of Scattered Toner Ejection Control Mode) The control method and the operation condition of the scattered toner ejection control mode will be described below. As the premise, the control ideas of the scattered toner ejection control modes for colors are the same. Accordingly, colors may not be described in the subsequent flowcharts or the like, but it should be noted in this case that common control is performed for the colors.

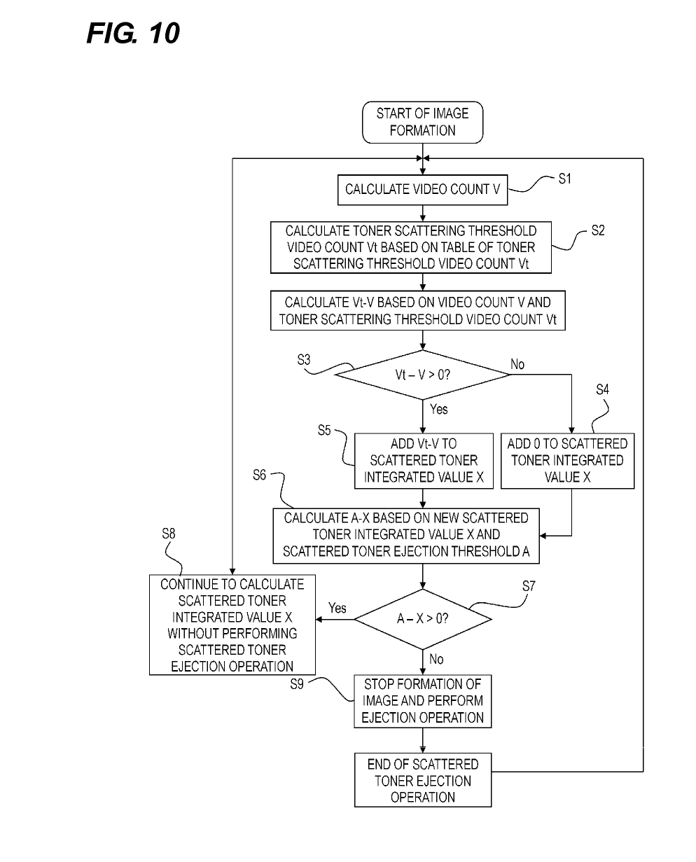

In this embodiment, an example in which an image (hereinafter, referred to as a “black low-duty image chart”) in which the printing rates per sheet for the colors of YMCK are Y=5%, M=5%, C=5%, and K=1% is continuously formed on A4-size sheets is considered. The toner ejection control at this time will be described with reference to the flowchart illustrated in FIG. 10. FIG. 10 is a flowchart illustrating a control flow up to the scattered toner ejection control according to the first embodiment.

As illustrated in FIG. 10, first, when formation of an image is started, the video signal count portion 207 calculates video counts V(Y), V(M), V(C), and V(K) of the colors (step S1). In this embodiment, the video count of an entire solid image (an image with a printing rate of 100%) on one side of an A4-size sheet for one color is defined to be 512. Then, the video counts of the “black low-duty image chart” are V(Y)=26, V(M)=26, V(C)=26, and V(K)=5. Here, in calculation of the video counts, the values are rounded off to the closest whole number.

Then, the toner scattering threshold video count Vt is calculated from the table of the toner scattering threshold video count Vt (see FIG. 9) acquired by the above-mentioned experiment or the like (step S2). Subsequently, the plus or minus of a difference between the video count V and the toner scattering threshold video count Vt, that is, Vt−V, is determined (step S3).

When Vt−V is minus (which includes 0. The same is true of the following description.), the printing rate is high. In this case, no toner aggregate is generated and scattered toner due to the aggregates does not progress. Accordingly, 0 is added to a scattered toner integrated value X (step S4). Here, the scattered toner integrated value X is an index indicating the current scattered toner state due to toner aggregates and is an integrated value of the video count values calculated from Vt−V. When Vt−V is minus, the scattered toner integrated value X does not increase. In step S4, 0 is added to the scattered toner integrated value X, but the invention is not limited to this example. For example, when Vt−V is minus, the minus value may be added thereto.

On the other hand, when Vt−V is plus, the printing rate is low. In this case, toner aggregates are generated and toner scattering due to the aggregates progresses. Accordingly, (Vt−V) is added to the scattered toner integrated value X (step S5).

Then, a difference (A−X) between a scattered toner ejection threshold A and the scattered toner integrated value X which is calculated and updated every a predetermined number of sheets on which an image is formed in the above-mentioned step is calculated (step S6). Here, the scattered toner ejection threshold A is a predetermined value which can be arbitrarily set, and the smaller the scattered toner ejection threshold A becomes, the greater the frequency in which the scattered toner ejection control operation is performed on the continuous formation of an image with the same printing rate becomes.

In this embodiment, the scattered toner ejection threshold A is set to 512. When the set value of the scattered toner ejection threshold A is excessively great, the time in which the toner aggregates are scattered into the apparatus until the scattered toner ejection operation is performed. Accordingly, the scattered toner ejection threshold A is preferably equal to the video count value of an entire solid image (an image with a printing rate of 100%) on one side of an A4 to A3 size sheet. For example, the greater the amount of developer which can be contained in the developing container 20 becomes, the greater the scattered toner ejection threshold A can be set.

Finally, the plus or minus of the difference (A−X) between the scattered toner integrated value X and the scattered toner ejection threshold A, which is calculated in the above-mentioned step, is determined (step S7).

Here, when (A−X) is plus, it is determined that the generation of the toner aggregates does not progress to such an extent to which the scattered toner ejection should be immediately performed. Accordingly, the formation of an image is continuously performed (step S8).

On the other hand, when (A−X) is minus, it is determined that the generation of toner aggregates sufficiently progresses and thus the scattered toner ejection needs to be immediately performed. In this case, the formation of an image is stopped and the scattered toner ejection operation is performed (step S9).

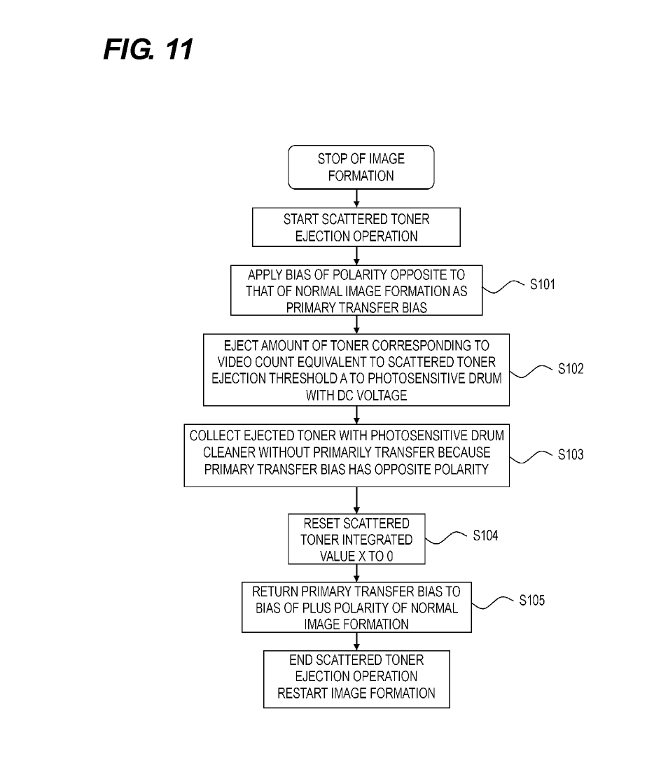

The scattered toner ejection operation will be described below with reference to FIG. 11. FIG. 11 is a flowchart illustrating a control flow of the scattered toner ejection control according to the first embodiment. In step S7, when (A−X) is minus, the formation of an image is stopped and the scattered toner ejection operation is performed (step S9).

As illustrated in FIG. 11, when the scattered toner ejection operation is started, a transfer bias having the polarity opposite to that for the normal image formation is applied as a primary transfer bias (step S101). The transfer bias having the polarity opposite to that of the normal image formation is a transfer bias having the same polarity as the toner image on the photosensitive drum 101.

Then, an amount of toner corresponding to the video count of the scattered toner ejection threshold A is ejected to the photosensitive drum 101 (step S102). An electrostatic latent image on the photosensitive drum for the toner ejection is preferably a halftone electrostatic latent image which is about half the entire solid image which is set to 255.

As a more important point, the development bias applied to the developing sleeve 24 during the scattered toner ejection operation needs to be a DC voltage. This is because the development method of the toner aggregates, which are generated by formation of an image with a low printing rate, onto the photosensitive drum 101 varies depending on the type of the development bias applied to the developing sleeve. In this way, a force for moving regularly-charged toner from the developing sleeve 24 to the photosensitive drum 101 acts when an image is not formed.

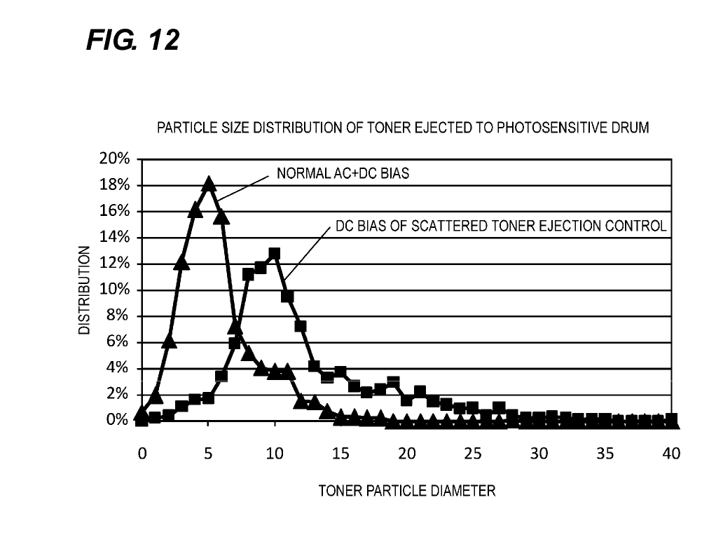

FIG. 12 is a diagram illustrating a particle diameter distribution of toner which is ejected in the scattered toner ejection control according to the first embodiment. FIG. 12 illustrates a particle diameter distribution of toner developed onto the photosensitive drum 101 when the developer standing for 10000 sheets at a printing rate of 1% is developed with a development bias. In FIG. 12, a case in which an electrostatic latent image shallower than that of normal image formation is developed with only a DC voltage and a case in which the electrostatic latent image is developed with a normal development bias having a DC voltage and an AC voltage superimposed are compared with each other.

As illustrated in FIG. 12, when the electrostatic latent image shallower than that of the normal image formation is developed with only a DC voltage, toner aggregates of 20 μm to 35 μm can be selectively developed. Accordingly, the development bias during the scattered toner ejection operation has only a DC voltage, unlike the normal image formation.

Referring to FIG. 11 again, since the primary transfer bias has the same polarity as the toner ejected onto the photosensitive drum 101, the toner is not transferred onto the intermediate transfer belt 121 but is collected by the drum cleaner 109 (step S103). The scattered toner integrated value X is reset to 0 (step S104).

Finally, the primary transfer bias is returned to the bias having the same polarity as the normal image formation (step S105), and the scattered toner ejection operation is completed and is then returned to the normal image forming operation. In this embodiment, the bias having the same polarity as the toner is applied as the primary transfer bias, but a method of applying the primary transfer bias having the same polarity as the toner and collecting the toner using the belt cleaner 114 may be employed similarly to the image formation.

Here, in the scattered toner ejection control method described above, a case in which an image of the “black low-duty image chart” is continuously formed on 10000 sheets is specifically considered.

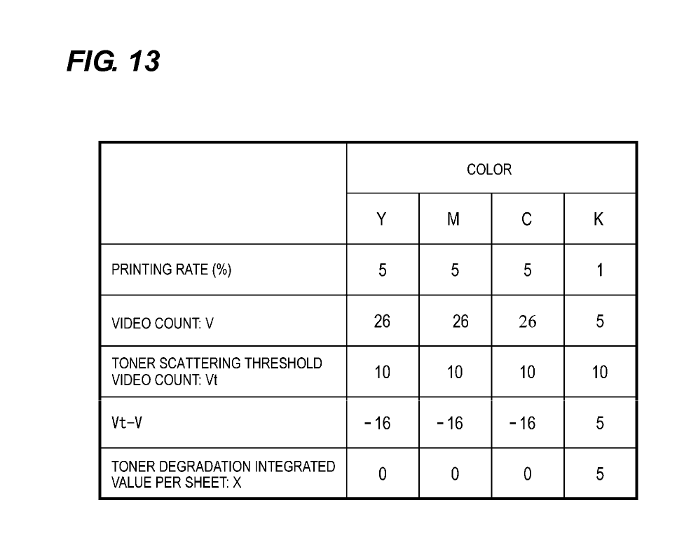

How to calculate the scattered toner integrated value X in the scattered toner ejection control of this embodiment when an image of the “black low-duty image chart” is formed on a sheet is illustrated in the table of FIG. 13. FIG. 13 is a table illustrating the scattered toner ejection control according to the first embodiment.

As illustrated in the table of FIG. 13, when an image of the “black low-duty image chart” is formed, the printing rates of Y (yellow), M (magenta), and C (cyan) are sufficiently high. Accordingly, the scattered toner integrated value X is always 0. On the other hand, the printing rate of K (black) is low. Accordingly, the scattered toner integrated value X for each sheet is +5. That is, this means that generation of toner aggregates of black toner progresses during the continuous image formation.

This will be more specifically described below. When the image of the “black low-duty image chart” is continuously formed on 10000 A4-size sheets, the scattered toner integrated value X for each sheet is +5. Accordingly, the scattered toner ejection operation is performed and the frequency thereof is 512/5=103 sheets (which is rounded off to the closet whole number) because the scattered toner ejection threshold A is 512.

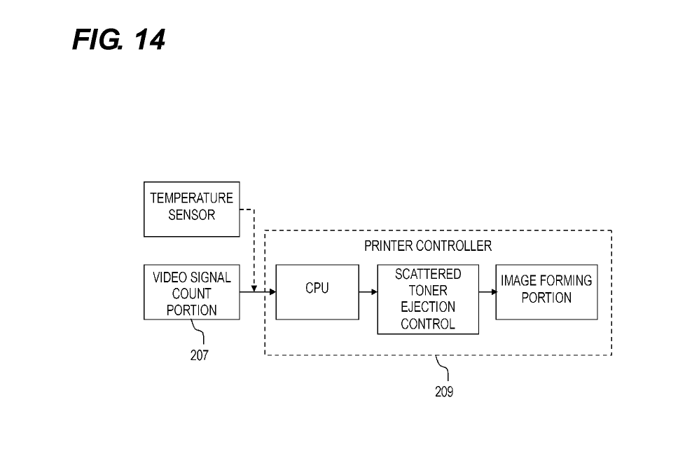

A simple control block diagram is illustrated in FIG. 14. FIG. 14 is a control block diagram illustrating the scattered toner ejection operation according to the first embodiment. As illustrated in FIG. 14, the result information of the video count is sent to the CPU. The CPU instructs the image forming portion to perform the scattered toner ejection operation according to the scattered toner ejection control described with reference to the flowcharts of FIGS. 10 and 11. The result of the temperature sensor 4T or the temperature sensor 100T is preferably sent to the CPU.

Accordingly, in this embodiment, in continuously forming an image of the “black low-duty image chart” on 10000 A4-size sheets, the image formation is stopped about 97 times and the scattered toner ejection is performed. An amount of toner corresponding to 1/10 of the video count 512 is consumed for one scattered toner ejection operation. In the scattered toner ejection control mode, a DC voltage which is different from that of the normal image formation is applied to the developing sleeve in order to selectively eject the toner aggregates causing the toner scattering. The amount of scattered toner can be suppressed by the above-mentioned operation.

### Second Embodiment

An image forming apparatus 100 according to a second embodiment will be described below in detail. In the first embodiment, the scattered toner ejection control has been described. On the other hand, in an actual image forming apparatus, when a printing rate is low, a degraded toner ejection control mode in which degraded toner is ejected with the same development bias as the normal image formation may be provided. This is a control method of preventing degradation in image quality and suppressing a decrease in productivity.

Specifically, there is a control method of calculating a value indicating an amount of toner used for each image formation and performing the degraded toner ejection control mode when the value is less than a predetermined threshold and the value acquired by integrating the difference therebetween reaches a predetermined value. The predetermined threshold is, for example, a video count value for each image formation.

The decrease in image quality due to the toner degradation can be prevented by the degraded toner ejection control mode. A specific example of the decrease in image quality is degradation in roughness or graininess. When the threshold for the amount of toner consumed and the threshold for the difference integrated value for determining whether the degraded toner ejection control mode should be performed are appropriately set, it is possible to effectively perform the degraded toner ejection control mode. That is, it is possible to perform the control of preventing the degradation in image quality and suppressing the decrease in productivity.

In the image forming apparatus having the degraded toner ejection control mode, when the scattered toner (aggregates) ejection control mode described in the first embodiment is not provided, the toner aggregates are accumulated and the scattered toner degrades. Therefore, in the second embodiment, the scattering level is improved by adding the scattering toner ejection control mode to the image forming apparatus having the degraded toner ejection control mode.

In the second embodiment, in consideration of the fact that the generation of toner aggregates of the developer depends on (1) the drive time of the developing sleeve, (2) the amount of toner consumed per unit time, and (3) the temperature of the developer at that time, the operation method of the scattered toner ejection control mode will be described.

(Control Method of Toner Ejection Control Mode) As a premise, the control idea of the toner ejection control mode is the same for the colors used for the image formation. Accordingly, when colors are not described in the subsequent flowcharts or the like, it represents that common control is performed regardless of the difference in toner color. The hardware configuration of the image forming apparatus 100 to which the second embodiment can be applied or the developer is the same as described in the first embodiment.

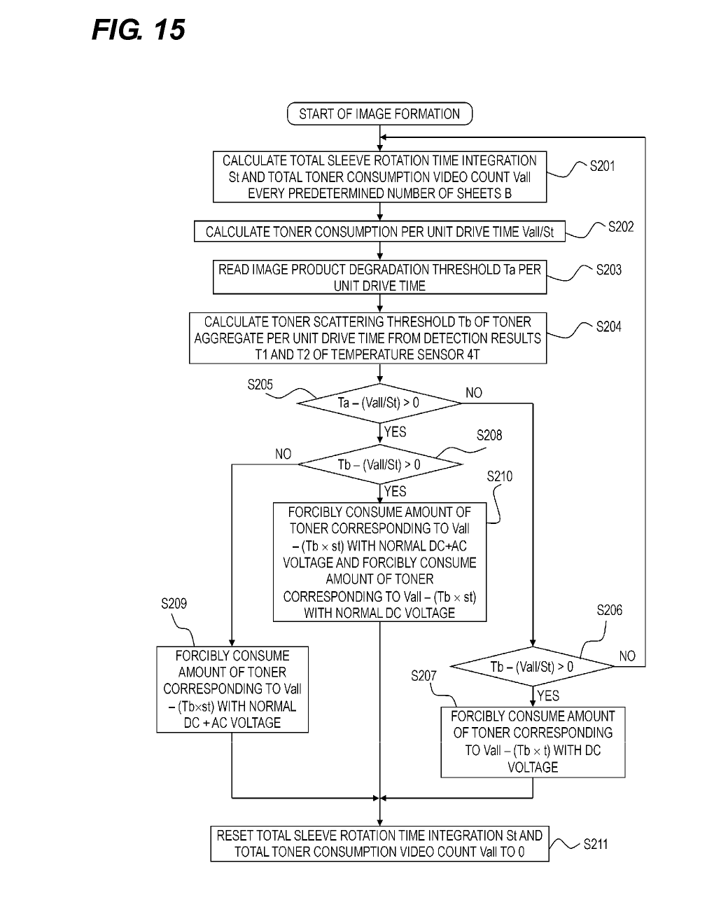

In the second embodiment, for the purpose of easy understanding, a case in which an image of the “black low-duty image chart” with printing rates of Y=5%, M=5%, C=5%, and K=1% for the colors of YMCK for each sheet is continuously formed on A4-size sheets will be considered. The toner ejection control mode is illustrated in FIG. 15. FIG. 15 is a flowchart illustrating a flow of the toner ejection control according to the second embodiment.

As illustrated in FIG. 15, a total sleeve rotation time integration St and a total toner consumption video count Vall are calculated every a predetermined number of sheets B (step S201). Here, the predetermined number of sheets B is a value which is arbitrarily determined in the image forming apparatus 100 according to this embodiment, and is preferably 100 sheets.

The total sleeve rotation time integration St is the total integration of the sleeve rotation time until image formation on the predetermined number of sheets B is completed after the image formation is started. The total sleeve rotation time integration St also includes the sleeve rotation time between sheets or in previous rotations.

The total toner consumption video count Vall is a value indicating the total amount of toner consumed until the image formation on the predetermined number of sheets B is completed after the image formation is started. The total toner consumption video count Vall also includes the video count due to the normal image formation of an original, which is calculated by the video signal count portion 207 illustrated in FIG. 3. The total toner consumption video count Vall also includes the amount of toner consumed by a density control patch, a toner replenishment control patch, a misregistration compensation patch, and the like which are formed in a non-imaged part of the photosensitive drum 101.

Here, the amount of toner consumed by the control path can be appropriately set by the image forming apparatus 100. For example, the density control path in this embodiment is a square patch with an area of 20 mm×20 mm and an amount of toner placed thereon is half that of a solid image. Accordingly, the video count corresponding to one density control patch is 512×(0.5)×((20×20)/(297×210))=2. 0.5 in this expression corresponds to the density and (20×20)/(297×210) corresponds to the area.

An amount of toner consumed per unit drive time (Vall/St) is calculated from the total sleeve rotation time integration St and the total toner consumption video count Vall which are calculated in the previous step (step S202). This is a value indicating the degree of toner degradation and the degree of generation of toner aggregates which causes toner scattering. Here, an image quality degradation threshold Ta and a scattering degradation threshold Tb are defined as the toner consumption threshold.

First, the threshold Ta of the amount of toner consumed per unit drive time will be considered. The threshold Ta represents an allowable level of image quality due to the toner degradation. The method of calculating the threshold Ta is as follows.

First, the developing device 104 is placed under a predetermined environment, and an image is continuously formed on one side of 10000 A4-size sheets while changing the printing rates of the colors (0% to 5%). Then, the variation in the image quality is checked before and after next continuous image formation is performed. That is, the video count of the normal image formation can be acquired from the printing rates and the video count of the amount of toner consumed by the control patch can be acquired from the number of sheets passing. By calculating the sum thereof, the total toner consumption video count Vall can be calculated. The total sleeve rotation time integration St can be measured. The correlation between the amount of toner consumed (Vall/St) per unit drive time and the image quality can be checked.

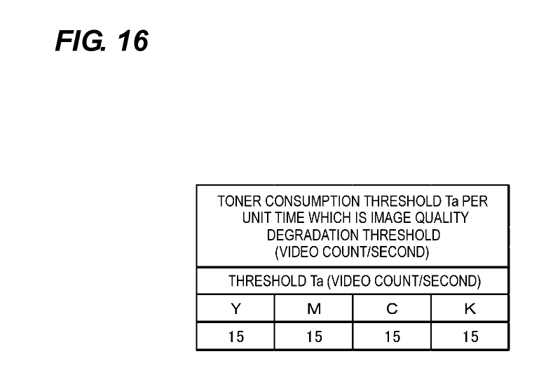

A specific example of the threshold Ta will be described below. FIG. 16 is a table illustrating the thresholds of the toner degradation in the colors in the second embodiment. The threshold Ta is an amount of toner consumed per unit drive time in which the toner of each color degrades in the image forming apparatus 100 according to this embodiment. Since the threshold Ta varies depending on colors or materials of the developer (toner and carriers), the configuration of the developing device, and the like, the threshold Ta can be appropriately calculated and set. The unit of the threshold Ta is “video count/second”.

Then, the amount of toner consumed Tb (which has temperature dependency) per unit drive time will be considered. The threshold Tb represents an allowable level of toner scattering degradation due to the generation of toner aggregates. The method of calculating the threshold Tb is as follows.

First, the developing device 104 is placed under various predetermined environments, and an image is continuously formed on one side of 10000 A4-size sheets while changing the printing rates of the colors (0% to 5%) under the predetermined environments. Then, the variation in image quality can be calculated by checking the variation in image quality before and after next continuous image formation is performed.

FIG. 17 is a table illustrating the thresholds of the temperature dependency of the scattering progress due to the toner aggregates in the colors in the second embodiment. The threshold Tb is a threshold of an amount of toner consumed per unit drive time in which the scattered toner due to the aggregates for the colors and at the temperatures progresses in the image forming apparatus 100 according to this embodiment. Since the threshold Tb varies depending on colors or materials of the developer (toner and carriers), the configuration of the developing device, and the like, the threshold Ta can be appropriately calculated and set. The unit of the threshold Tb is “video count/second”.

Description will be made with reference to the flowchart of FIG. 15 again. In forming an image on a predetermined number of sheets B, the threshold Ta of the amount of toner consumed per unit drive time is read from the table illustrated in FIG. 16 (step S203). The threshold Tb at the average temperature of the sensing results T1 (before) and T2 (after) of the temperature sensor 4T before and after an image is formed on the predetermined number of sheets B is calculated from the table illustrated in FIG. 17 (step S204). Then, the plus or minus of the difference between the amount of toner consumed (Vall/St) per unit drive time and the threshold Ta, that is, Ta−(Vall/St), is determined (step S205).

When it is determined in step S205 that Ta−(Vall/St) is 0 or minus, this means that the amount of toner consumed per unit drive time is great enough and the degradation in image quality does not progress. Therefore, in a subsequent step, the plus or minus of the difference between the amount of toner consumed (Vall/St) per unit drive time and the threshold Tb, that is, Tb−(Vall/St), is determined to determine the progress level of the scattered toner due to the toner aggregates (step S206).

When it is determined in step S206 that Tb−(Vall/St) is 0 or minus, it can be seen that the amount of toner consumed per unit drive time is great enough and the degradation in image quality does not progress. Accordingly, the toner ejection operations are not performed and the normal image formation is continuously performed.

When it is determined in step S206 that Tb−(Vall/St) is plus, this means that the amount of toner consumed per unit drive time is small and the degradation in image quality progresses. Therefore, the toner ejection control mode in which an amount of toner corresponding to the video count calculated by Vall−(Tb×St) is consumed with the developing bias of only a DC voltage which is different from that of the normal image formation is performed (step S207). Thereafter, the total sleeve rotation time integration St and the total toner consumption video count Vall are reset to 0 (step S211) and the normal image formation is continuously performed.

When it is determined in step S205 that Ta−(Vall/St) is plus, it can be seen that the amount of toner consumed per unit drive time is small and the degradation in image quality progresses. Therefore, in a subsequent step, the plus or minus of the difference between the amount of toner consumed (Vall/St) per unit drive time and the threshold Tb, that is, Tb−(Vall/St), is determined to determine the progress level of the scattered toner due to the toner aggregates (step S208).

When it is determined in step S208 that Tb−(Vall/St) is 0 or minus, it can be seen that the amount of toner consumed per unit drive time is great enough and the degradation in image quality does not progress. Accordingly, in order to maintain the image quality, only the degraded toner ejection operation of consuming an amount of toner corresponding to the video count calculated by Vall−(Ta×St) with the normal development bias having a DC voltage and an AC voltage superimposed is performed (step S209). Thereafter, the total sleeve rotation time integration St and the total toner consumption video count Vall are reset to 0 (step S211) and the normal image formation is continuously performed.

When it is determined in step S208 that Tb−(Vall/St) is plus, this means that the amount of toner consumed per unit drive time is small and the scattered toner due to the toner aggregates progresses. Therefore, in order to maintain the image quality, only the degraded toner ejection operation of consuming an amount of toner corresponding to the video count calculated by Vall−(Ta×St) with the normal development bias having a DC voltage and an AC voltage superimposed is performed.

In addition, the scattered toner ejection control mode in which an amount of toner corresponding to the video count calculated by Vall−(Tb×St) with the development bias of only a DC voltage which is different from the normal image formation is also performed (step S210). Thereafter, the total sleeve rotation time integration St and the total toner consumption video count Vall are reset to 0 (step S211) and the normal image formation is continuously performed.

The image forming operations (the setting of the transfer bias, the operation order, or the like) in the toner ejection control modes are substantially the same as described in FIG. 11 according to the first embodiment. The reset operation (the operation of steps S104 to S105 in FIG. 11) illustrated in FIG. 11 is performed in step S211 in this embodiment. It should be noted that the ejection using a development bias having only a DC voltage, the ejection using a development bias having a DC voltage and an AC voltage superimposed, and the ejection using both biases are properly used depending on the ejection conditions.

The control is performed based on the flowchart illustrated in FIG. 15 as described above. Specifically, black when an image of the “black low-duty image chart” is continuously formed on 10000 A4-size sheets in the image forming apparatus 100 according to this embodiment which is placed in a fixed environment of a room temperature of 23° C. and humidity of 50% will be considered.

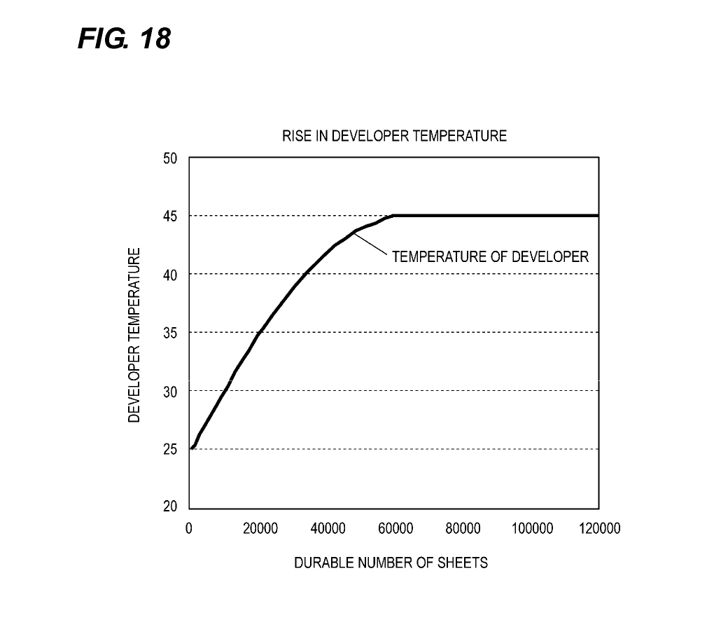

In this case, the sensing result of the developer temperature using the temperature sensor 4T is illustrated in FIG. 18. FIG. 18 is a graph illustrating a temperature rise of a developer when images are continuously formed according to the second embodiment. In FIG. 18, the horizontal axis represents the number of sheets standing and the vertical axis represents the sensing result of the temperature sensor 4T.

As can be read from the graph illustrated in FIG. 18, even when the environment in which the image forming apparatus 100 is placed is maintained constant (at a room temperature of 23° C. and humidity of 50%), the sensing result of the temperature sensor 4T (that is, the temperature of the developer) rises (saturated in the vicinity of 45° C.). This is because there is an automatic temperature rise due to the rotation of the developing sleeve 24 or the transport screws or an automatic temperature rise due to other motors or the like in the image forming apparatus 100 in the developing device 104. In this way, since the temperature of the developer rises with the progress of the duration, the generation of toner aggregates progresses and thus the frequency of the toner ejection control using the development bias of a DC voltage needs to be increased. Alternatively, the amount of toner ejected needs to be increased.

When the predetermined number of sheets B is set to 100 in the flowchart illustrated in FIG. 15, the total sleeve rotation time integration St at the predetermined number of sheets B=100 is St=200 seconds in this embodiment.

The total toner consumption video count Vall at the predetermined number of sheets B=100 is Vall=520. This is because the video count is 5 for each sheet is 5 and one video count of the density control patch which is performed every 10 sheets during the continuous image formation is 2. In this embodiment, the toner replenishment control patch and the misregistration compensation patch have small frequencies of forming the patches and the amounts of toner consumed thereof are small and thus are neglected. Accordingly, the amount of toner consumed (Vall/St) per unit drive time is (Vall/St)=2.6 (which is rounded off to the closest whole number).

The calculated amount of toner consumed (Vall/St)=2.6 per unit drive time during the image formation of the predetermined number of sheets B=100, the threshold Ta associated with the image quality illustrated in the tables of FIGS. 16 and 17, and the threshold Tb associated with the scattered toner due to toner aggregates are compared. Regarding the threshold Ta, since the amount of toner consumed is small, the toner ejection for maintaining the image quality needs to be performed every 100 sheets.

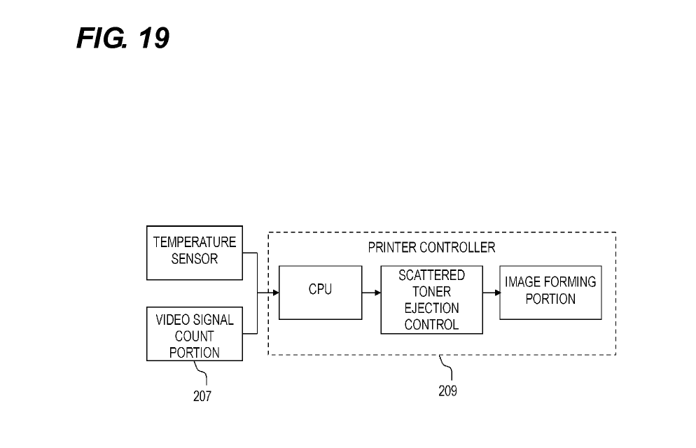

On the other hand, regarding the threshold Tb, since the amount of toner consumed is greater at a temperature of 35° C. or lower, the toner ejection is not performed. That is, the ejection using the development bias of a DC voltage is not performed up to 2000 sheets. However, between 2000 sheets and 10000 sheets, the device temperature is equal to or higher than 35° C. and the amount of toner consumed is less than the threshold Tb. Accordingly, the toner ejection using the development bias of a DC voltage is performed. The toner ejection control in this embodiment is based on the control block diagram illustrated in FIG. 19. FIG. 19 is a control block diagram illustrating the toner ejection operation according to the second embodiment.

That is, it is possible to provide an image forming apparatus in which the frequency and downtime of toner ejection of suppressing the scattered toner due to the toner aggregates using the development bias of a DC voltage is increased with a rise in the device temperature. It is possible to appropriately suppress the scattered toner due to the toner aggregates by the control described above in this embodiment.

As described above, according to the invention, it is possible to excellently prevent scattered toner with an inexpensive configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-118352, filed Jun. 9, 2014 which is hereby incorporated by reference herein in its entirety.

What is claimed is:

1. An image forming apparatus comprising:
an image bearing member;
a developer containing portion that contains a developer including toner;
a developer bearing member that bears the developer in the developer containing portion and that supplies the developer to an electrostatic latent image formed on the image bearing member;
a toner replenishment portion that replenishes the developer containing portion with toner;
a power supply portion that applies an AC voltage or a voltage in which a DC voltage and an AC voltage are superimposed to the developer bearing member at least during image formation;
an information obtaining portion which obtains information concerning toner consumption amount;
a temperature sensing portion that senses a temperature in the image forming apparatus; and
a controller which can perform a scattered toner ejection control mode in which toner is discharged from the developer bearing member to a region on the image bearing member corresponding to an interval between a preceding recording material and a subsequent recording material while applying only a DC voltage to the developer bearing member based on the information obtained by the information obtaining portion during an image forming period in which an image is successively formed on recording materials and a degraded toner ejection control mode in which toner is discharged from the developer bearing member to a region on the image bearing member corresponding to an interval between a preceding recording material and a subsequent recording material while applying at least an AC voltage to the developer bearing member based on the information obtained by the information obtaining portion during an image forming period in which an image is successively formed on recording materials, the controller changing a performing ratio of the scattered toner ejection control mode to the degraded toner ejection control mode depending on the temperature sensed by the temperature sensing portion.

2. The image forming apparatus according to claim 1,
wherein the controller increases the performing ratio of the scattered toner ejection control mode to the degraded toner ejection control mode as the temperature sensed by the temperature sensing portion becomes higher.

3. The image forming apparatus according to claim 1,
wherein the controller integrates the amount of the consumed toner and a drive time of the developer bearing member and performs the degraded toner ejection control mode when the amount of the consumed toner per unit drive time of the developer bearing member is lower than a predetermined threshold.

4. The image forming apparatus according to claim 1,
wherein the controller increases an amount of toner ejected or an ejection frequency in the degraded toner ejection control mode as the temperature sensed by the temperature sensing portion becomes higher.

5. The image forming apparatus according to claim 1,
wherein an AC voltage or a voltage in which a DC voltage and an AC voltage are superimposed is applied to the developer bearing member in an imaged part of the image bearing member.

6. The image forming apparatus according to claim 1,
wherein the toner includes a binder resin and a glass transition temperature Tg of the binder resin is equal to or lower than 70° C.

7. The image forming apparatus according to claim 1,
wherein the toner includes wax.
